(19) United States
(12) Patent Application Publication
(10) Pub. No.: US 2009/0113463 A1
(43) Pub. Date: Apr. 30, 2009

(54) Optical Disk Reproducing Device

(75) Inventor: Wen-Chin Chang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/253,443

(22) Filed: Oct. 17, 2008

(30) Foreign Application Priority Data
Oct. 30, 2007 (CN) 200710184858.8

(51) Int. Cl. G11B 7/00

(52) U.S. Cl. 720/660; G9B/7

(57) ABSTRACT

The present invention is directed to an optical disk reproducing device including an external optical disk drive and a detachable module. The external optical disk drive reproduces data from the optical disk. The detachable module has an audio output or video output connector. Besides, the external optical disk drive has a first connector and the detachable module has a corresponding second connector. The detachable module is connected with an audio output device or a video output device via the audio output connector or the video output connector respectively. After data is processed in the external disk drive, the data is sent to the control chip for further processing. The data processed by the control chip is sent to the audio output device or the video output device.

### BACKGROUND OF THE INVENTION

1. Field of the Invention

The present invention relates to an optical disk reproducing device, and in particular to an optical disk reproducing drive having a detachable module for audio/video output or data processing.

2. Description of the Prior Art

With the advent of optical storage device, external optical disk drives are becoming more popular in the market. The users easily move the external optical disk drive from one system to another, and it's also convenient for the users to plug the external optical disk drive to system or unplug the external optical disk drive from the system.

FIG. 1 illustrates the relationship between the external optical disk drive and the host computer in the prior art. An external optical disk drive 1 is connected to a host computer 2 by a universal serial bus (USB) port, and the host computer 2 includes an audio adapter 3 and a video adapter 4. When the external optical disk drive 1 is in use (i.e. audio playback or video playback), the host computer 2 receives the audio or video data from the external optical disk drive 1 via a USB line. After the data is processed by the host computer 2, the audio data and the video data are be sent to the audio adapter 3 and the video adapter 4, respectively. Finally, the audio data is sent from the audio adapter 3 to the audio output device 5 (e.g. stereo speaker) through a connector. Likely, the video data is sent from the video adapter 4 to the video output device 6 (e.g. monitor) through a 15-pin or 20-pin connector.

However, it is not convenient for the user to listen to music or watch video disk when the user just have the external optical disk drive. Moreover, the user needs a specified connecting line for connecting the external optical disk drive and the host computer. One end of the connecting line is connected to the external optical disk drive 1 by a specified connector, and the other end is connected to the host computer 2 through the USB port. Thus, the external optical disk drives require specified connector and must be connected with the host computer when the user want to listen to music or watch video disk in the prior art.

Accordingly, there is need to develop an optical disk reproducing device having a detachable module for audio/video output or data processing. Thus, it's very convenient for the user to enjoy the music or video playback.

### SUMMARY OF THE DISCLOSURE

It is an object of the present invention to provide an optical disk reproducing device having a detachable module for audio/video output or data processing.

The optical disk reproducing device of the present invention includes an external optical disk drive and a detachable module. The external optical disk drive has a first connector and the detachable module has a second connector corresponding to the first connector. The detachable module further includes a control chip and an audio output connector and a video output connector for connecting an audio output device or a video output device, respectively. The external optical disk drive is attached to the detachable module by snapping the first connector into the second connector. The external optical disk drive can reproduce the optical disk, and the detachable module is equipped with a control chip, an audio output connector or a video output connector. After data is processed in the external optical disk drive, the data is sent to the control chip for further processing. Then the data processed by the control chip is sent to the audio output device or the video output device.

### BRIEF DESCRIPTION OF DRAWINGS

The present invention can be fully understood from the following detailed description and preferred embodiment with reference to the accompanying drawings in which:

FIG. 1 is a block diagram illustrating the relationship of an external optical disk drive and the host computer in the prior art; and

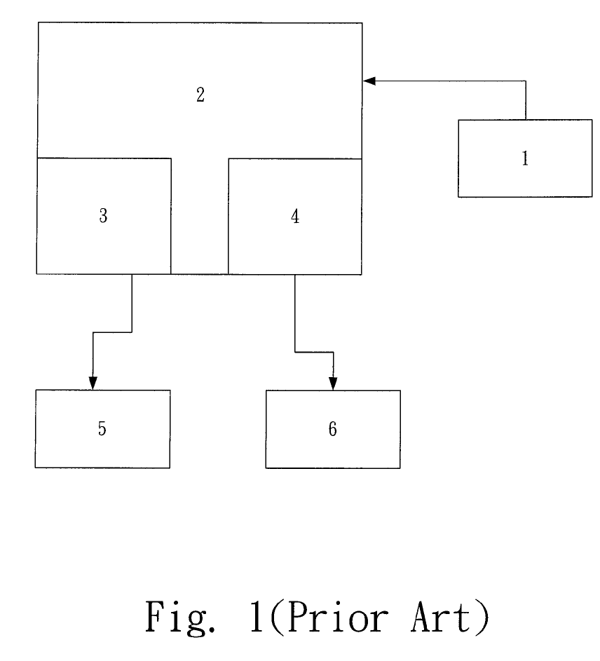

FIG. 2 is a block diagram illustrating an optical disk reproducing device of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the embodiments of the present invention are described below in connection with an external optical disk drive, the present invention can be applied to all optical disk drive, including but not limited to CD-ROM drives, DVD-ROM drives, CD-RW drives, DVD-RAM drives, DVD-RW drives, DVD+RW drives, COMBO drives, BD drives, HD-DVD drives, car audio players, external drives, as well as all other optical media recorders and players.

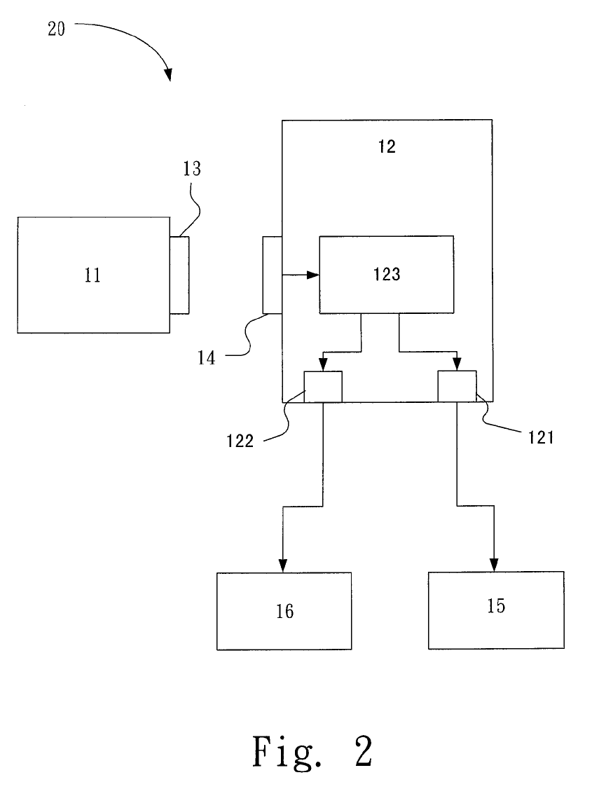

FIG. 2 illustrates an optical disk reproducing device 20 according to the present invention, and the interconnections of the components of the optical disk reproducing device 20.

Referring to FIG. 2, the optical disk reproducing device 20 of the present invention includes an external optical disk drive 11 and a detachable module 12. The external optical disk drive 11 has a first connector 13, and the detachable module 12 has a corresponding second connector 14. The connector 13 is an USB connector (plug) or IDE connector or pin-to-pin male connector and accordingly the corresponding second connector 14 is an USB socket or IDE connector or pin-to-pin female connector.

The external optical disk drive 11 reproduces optical disks or do music/movie playback. The detachable module 12 can include, but not limited to an audio output connector, a video output connector, a microphone in connector or other multimedia connectors. In this embodiment, the detachable module 12 includes an audio output connector 121 and a video output connector 122. Besides, the detachable module 12 is connected with an audio output device 15 and a video output device 16 via the audio output connector 121 and the video output connector 122, respectively.

Furthermore, when the user connects the external optical disk drive 11 to the detachable module 12, the connector 13 (USB connector) of the external optical disk drive 11 is connected into the corresponding connector 14 (USB socket) of the detachable module 12. Then, the user can place an optical disk (not shown) in the external optical disk drive 11 for reproducing the data. The data reproduced by the external optical disk drive 11 is sent to the control chip 123 for further processing. The control chip 123 transforms the data into another format for audio/video playing. Then the data processed by the control chip 123 is sent to the audio output device 15 and the video output device 16.

Therefore, all the user has to do is connect the external optical disk drive 11 to the detachable module 12, and the data is sent to the audio output device 15 or video output device 16 without connecting the external optical disk drive 11 to the host computer 2. The user easily enjoys music or movie playback by the optical disk reproducing device 20.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. An optical disk reproducing device, comprising:
an external optical disk drive, including a first connector; and
a detachable module, including a second connector corresponding to the first connector,
an audio output connector, a video output connector and a control chip;
wherein the external optical disk drive is connected to the detachable module and the data reproduced by the external optical disk drive is sent to the control chip for further processing;
wherein the data processed by the control chip is sent to the audio output connector and the video output connector.

2. The optical disk reproducing device as claimed in claim 1, wherein the detachable module is connected with an audio output device or a video output device via the audio output connector or the video output connector respectively.

3. The optical disk reproducing device as claimed in claim 1, wherein the first connector of the external optical disk drive is an USB connector, and the second connector of the detachable module is an USB socket.

4. The optical disk reproducing device as claimed in claim 1, wherein the first connector of the external optical disk drive is an IDE connector, and the second connector of the detachable module is an IDE connector.

5. The optical disk reproducing device as claimed in claim 1, wherein the first connector of the external optical disk drive is a pin-to-pin male connector, and the second connector of the detachable module is a pin-to-pin female connector.
